(19) United States
(12) Patent Application Publication
(10) Pub. No.: US 2026/0342237 A1
(43) Pub. Date: Oct. 29, 2026

(54) SECONDARY SIDE CONTROLLER FOR ISOLATED POWER CONVERTER

(71) Applicant: Renesas Design (UK) Limited, Bourne End (GB)

(72) Inventor: Yimin CHEN, San Jose, CA (US)

(73) Assignee: Renesas Design (UK) Limited, Bourne End (GB)

(21) Appl. No.: 19/191,210

(22) Filed: Apr. 28, 2025

(51) Int. Cl. H02M 3/335; H02M 1/00

(52) U.S. Cl. CPC H02M 3/33592; H02M 1/0006; H02M 1/0045

(57) ABSTRACT

A secondary side controller for use with an isolated power converter is provided. The secondary side controller includes a first capacitor for supplying a voltage to a power switch of a secondary side of the isolated power converter, a second capacitor, a third capacitor and a network of switches coupled to the first, second and third capacitors. The network of switches operates in a first phase to charge the second and third capacitors; and a second phase to charge the first capacitor by discharging the second and third capacitors.

### TECHNICAL FIELD

The present disclosure relates to a secondary side controller for isolated power converter.

### BACKGROUND

An isolated switching power converter uses a transformer to electrically isolate the input side and the output side, hence preventing direct current flow. Power is transferred between the input side and the output side via induction.

Isolated switching power converters may be used with various topologies and for various applications. For instance, a flyback switching power converter may be used to charge a mobile device as the converter's transformer provides safe isolation from AC household current. The primary input side and the secondary output side are controlled separately. Various controller designs have been proposed. For instance, U.S. Pat. No. 11,817,790B2 describes a high-side synchronous rectifier driver having an actively controlled controller power supply voltage. However, when the output voltage falls below a certain value, for instance below 6V, the converter experiences significant power losses.

It is an object of the disclosure to address one or more of the above-mentioned limitations.

### SUMMARY

According to a first aspect of the disclosure, there is provided a secondary side controller for use with an isolated power converter, the secondary side controller comprising a first capacitor for supplying a voltage to a power switch of a secondary side of the isolated power converter; a second capacitor; a third capacitor; and a network of switches coupled to the first, second and third capacitors, the network of switches being operable in a first phase to charge the second and third capacitors; and a second phase to charge the first capacitor by discharging the second and third capacitors.

Optionally, when the power switch is switched on, the network of switches operates in the first phase, and when the power switch is switched off, the network of switches operates in the second phase.

For instance, the power switch may be a synchronous rectifier switch such as a SR-MOSFET switch.

Optionally, wherein in the second phase the second and third capacitors are coupled in parallel when an output voltage of the isolated power converter is above a first threshold value; and wherein in the second phase the second and third capacitors are coupled in series when the output voltage is equal to or below the first threshold value.

For instance, the first threshold value may be a predetermined value. The predetermined value may be set by a user and/or may be based on the implementation of the isolated power converter.

Optionally, the network of switches comprises: a first switch coupling a first terminal of the first capacitor to a first terminal of the second capacitor; a second switch coupling the first terminal of the second capacitor to a first terminal of the third capacitor; a third switch coupling a second terminal of the second capacitor to the first terminal of the third capacitor; a fourth switch coupling the first terminal of the first capacitor to a second terminal of the third capacitor; a fifth switch coupling the second terminal of the second capacitor to the second terminal of the third capacitor.

For instance, the first terminal of the first capacitor may be negative and the second terminal of the first capacitor positive; while the first terminal of the second capacitor is positive and its second terminal negative; and the first terminal of the third capacitor is positive and its second terminal negative.

Optionally, wherein in the first phase the first switch, the second switch, and the fifth switch are switched on; while the fourth switch and the third switch are switched off.

Optionally, wherein in the second phase the second switch, the fourth switch and the fifth switch are switched on; while the first switch, and the third switch are switched off to couple the second and third capacitors in parallel, when the output voltage is above the first threshold value; and wherein in the second phase, the fourth switch and the third switch are switched on; while the first switch, the second switch and the fifth switch are switched off to couple the second and third capacitors in series, when the output voltage is equal or below the first threshold value.

Optionally, wherein a second terminal of the first capacitor is coupled to the first terminal of the second capacitor via a voltage regulator.

For instance, the voltage regulator may be a linear voltage regulator such as a Low-dropout regulator (LDO).

Optionally, wherein the network of switches is coupled to ground via a diode.

Optionally, the secondary side controller as claimed in claim 1, further comprises a driver for driving a control terminal of the power switch.

For instance, the control terminal may be a gate terminal of the power switch.

According to a second aspect of the disclosure there is provided an isolated power converter comprising: a primary winding having a first terminal for receiving an input voltage and a second terminal coupled to a primary side ground via a primary power switch; a secondary winding having a first terminal coupled to an output port via a secondary power switch and a second terminal coupled to a secondary side ground; and a secondary side controller as claimed in claim 1, coupled to the secondary power switch.

Optionally, wherein the first capacitor of the secondary side controller is coupled to a first terminal of the secondary power switch. For instance, the first terminal of the secondary power switch may be a source terminal.

Optionally, wherein the secondary power switch is a synchronous rectifier switch. For instance, the secondary power switch may be a synchronous rectifier MOSFET.

Optionally, the isolated power converter is implemented as a flyback converter. For instance, the flyback converter may be a DC/DC converter or an AC/DC converter.

According to a third aspect of the disclosure, there is provided a method of controlling a secondary side of an isolated power converter, the method comprising:
providing a first capacitor for supplying a voltage to a power switch of the secondary side of the isolated power converter;
providing a second capacitor and a third capacitor;
providing a network of switches coupled to the first, the second and the third capacitors;
operating the network of switches in a first phase to charge the second and third capacitors; and
operating the network of switches in a second phase to charge the first capacitor by discharging the second and third capacitors.

Optionally, the method comprises:
coupling the second and third capacitors in parallel during the second phase,
when an output voltage of the isolated power converter is above a first threshold value; and
coupling the second and third capacitors in series during the second phase, when the output voltage is equal to or below the first threshold value.

### DESCRIPTION OF THE DRAWINGS

The disclosure is described in further detail below by way of example and with reference to the accompanying drawings, in which:

FIG. 1 is a diagram of an isolated flyback converter according to the prior art;

FIG. 2 is a diagram of another isolated flyback converter according to the prior art;

FIG. 3 is a diagram of a SR controller according to the prior art;

FIG. 4 is a diagram of a SR controller as described in U.S. 11,817,790 B2;

FIG. 5 is a flow chart of a method of controlling a secondary side of an isolated power converter according to the disclosure;

FIG. 6 is a diagram of the secondary side of an isolated power converter, showing a secondary side controller for implementing the method of FIG. 5;

FIG. 7A is a diagram showing operation of the secondary side controller of FIG. 6 in the first phase;

FIG. 7B is a diagram showing the operation of the secondary side controller of FIG. 6 in the second phase when the output voltage is above a threshold value;

FIG. 7C is a diagram showing the operation of the secondary side controller of FIG. 6 in the second phase when the output voltage is equal or below a threshold value;

FIG. 8A is a waveform diagram illustrating operation of the secondary side controller of FIG. 6 when the output voltage is above the threshold value; and

FIG. 8B is a waveform diagram illustrating operation of the secondary side controller of FIG. 6 when the output voltage is equal or below the threshold value.

### DESCRIPTION

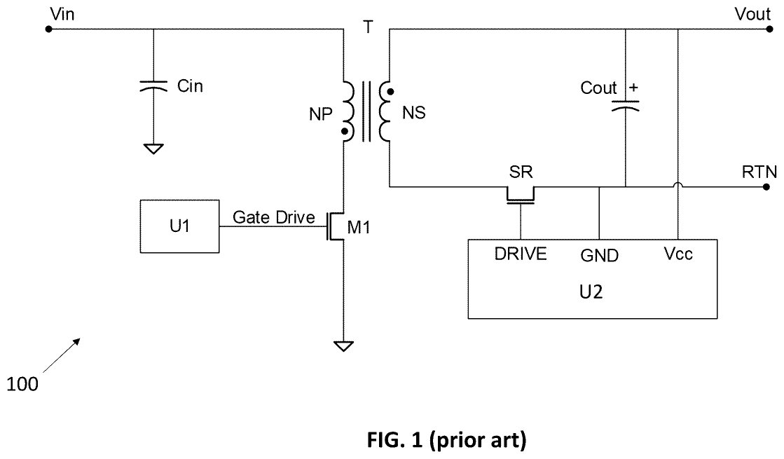

FIG. 1 illustrates an isolated flyback converter according to the prior art. The flyback converter 100 has a primary side and a secondary side. The primary side includes a primary winding having a first terminal for receiving an input voltage Vin and a second terminal coupled to the primary side ground via a primary power switch M1. The power switch M1 is controlled by a primary driver U1.

The secondary side includes a secondary winding having a first terminal coupled to an output port to provide the voltage Vout, and a second terminal coupled to a return port RTN via a synchronous rectifier (SR) switch MOSFET, SR-MOSFET. The SR-MOSFET is controlled by a SR controller also referred to as secondary driver U2.

The SR controller mimics a diode operation by turning ON the SR-MOSFET during forward bias conditions and turning OFF the SR-MOSFET during reverse bias conditions. For single output converters, the simplest implementation is to place the SR-MOSFET in the return path (GND). This is because the SR controller has a gate drive referenced to GND. As a result, the voltage Vcc generation for the SR controller can be easily tapped from the output voltage rail Vout. However, in operation the switching of the SR-MOSFET introduces high frequency noise on the GND node, causing increased EMI noise generation.

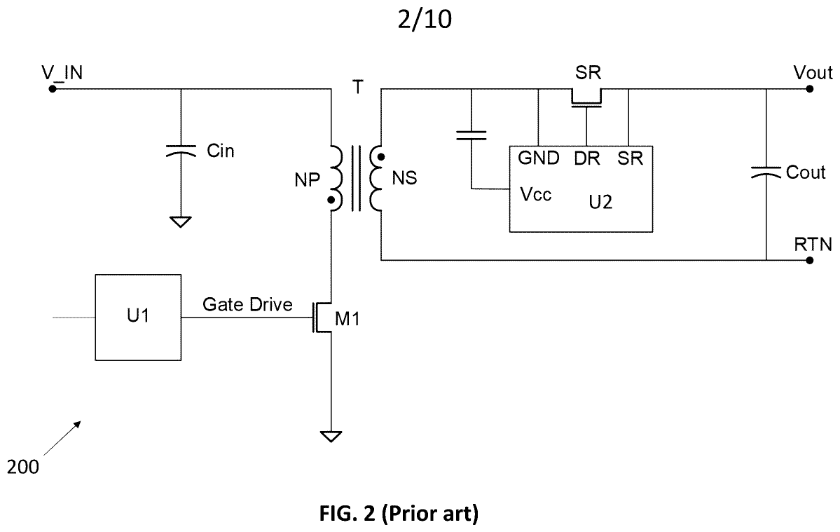

FIG. 2 illustrates another isolated flyback converter according to the prior art. The flyback converter 200 is similar to the example of FIG. 1, but in this case the SR-MOSFET is placed in series with the output voltage node to avoid increased EMI. This topology results in a floating SR MOSFET gate. In addition, the Vcc generation and the gate drive circuits are more complicated and have greater power dissipation.

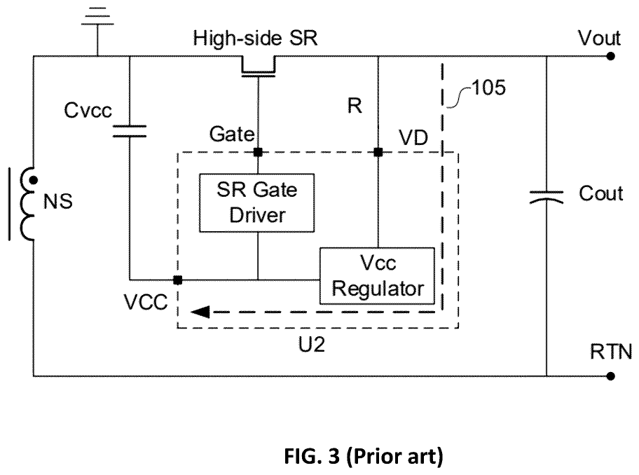

FIG. 3 illustrates a SR controller according to the prior art. The power supply (Vcc) for the high side SR controller comes from the winding voltage when the primary side turns on in the flyback converter. This approach results in high power losses (Ploss). For example, when:

Icc=1.2 mA, Vin=370V, Vout=28V, Nps=4, VCC=7V;

Ploss=(Vin/Nps+Vout−Vcc)*Icc=(370/4+28−7)*1.2 mA=136 mW.

The power loss is dissipated in the SR controller U2 and causes thermal issues for the device.

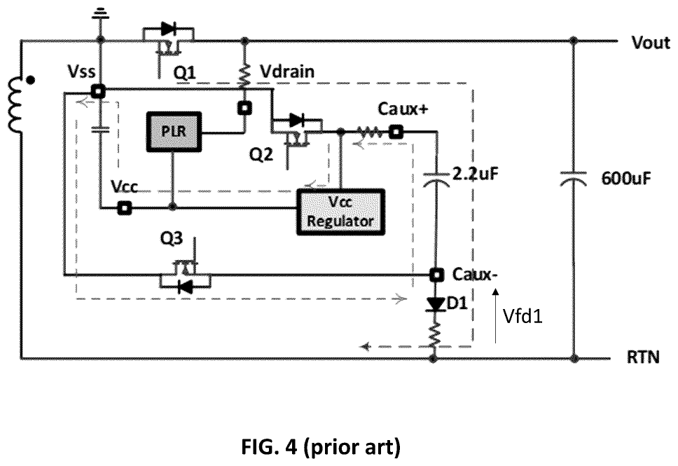

FIG. 4 illustrates a SR controller as described in U.S. Pat. No. 11,817,790 B2. The circuit 400 aims at reducing the Vcc charging losses and operates as follows.

When the SR MOSFET Q1 is turned ON (forward bias period), the primary power switch on the primary side (not shown) is turned OFF. The switch Q2 is ON while the switch Q3 is OFF.

When the SR MOSFET Q1 is turned OFF (reverse bias period), the primary power switch on the primary side (not shown) is turned ON. The switch Q2 is OFF while the switch Q3 is ON. The auxiliary capacitor Caux is charged to Vout−Vfd1, in which Vfd1 is the voltage across the diode D1. The auxiliary capacitor charges the capacitor Cvcc if Vcaux>Vcc.

When Vout>6V, the power loss in Vcc charging is relatively low. For comparison with FIG. 3 and using the same conditions (Icc=1.2 mA, Vin=370V, Vout=28V, Nps=4, VCC=7V), Ploss=(Vcaux−Vfd1−Vcc)* Icc=(28−0.5−7)*1.2 mA=25 mW (Versus 159 mW in FIG. 3).

However, when Vout<6V, the Caux voltage is not high enough to drive the SR MOSFET. The SR MOSFET turn-on threshold is typically 3 to 4V. To fully turn on the SR MOSFET, Vcc needs to be >=6V. When Vout is at 5V, for example, Vcaux is only 4.5V. As a result, the second VCC regulator (implemented as a Pulse Linear Regulator PLR or LDO) is enabled when Vout<6.5V. The power loss of PLR at Vout=5V is Ploss=(370/4+5−7)*1.2 mA=109 mW.

The standard output voltage for USB charging is 5V. There is therefore a need for a high efficiency Vcc generation for SR control implemented on the high-side rail.

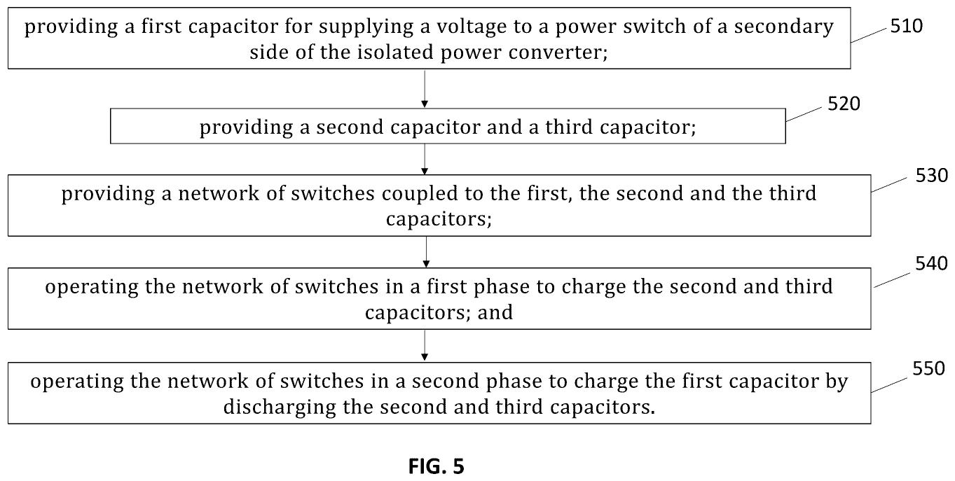

FIG. 5 is a flow chart of a method of controlling a secondary side of an isolated power converter according to the disclosure.

At step 510 a first capacitor is provided for supplying a voltage to a power switch (Q1) of a secondary side of the isolated power converter. At step 520 a second capacitor and a third capacitor are provided. At step 530 a network of switches coupled to the first, the second and the third capacitors is provided. At step 540 the network of switches is operated in a first phase to charge the second and third capacitors. At step 550 the network of switches is operated in a second phase to charge the first capacitor by discharging the second and third capacitors.

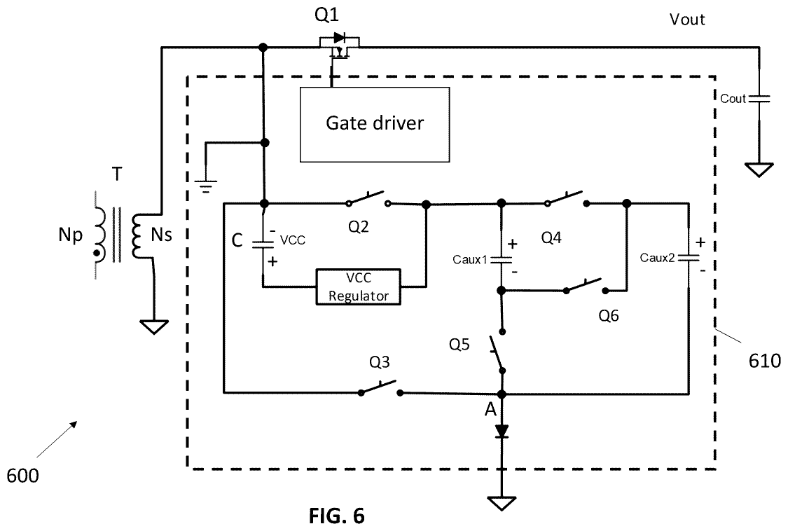

FIG. 6 is a diagram of the secondary side of an isolated power converter, showing a secondary side controller for implementing the method of FIG. 5.

The secondary side of the power converter has a power switch Q1 coupled to the secondary side controller 610. The power switch Q1 may be a synchronous rectifier (SR) switch MOSFET, SR-MOSFET.

The switch Q1 has a first terminal (for instance a source) coupled to the secondary winding Ns of a transformer T, a second terminal (for instance a drain) coupled to an output capacitor Cout, and a third terminal (for instance a gate) coupled to a driver, here referred to as gate driver.

The secondary side controller includes a first capacitor C for supplying a voltage to the power switch Q1, a second capacitor Caux1, a third capacitor Caux2, and a network of switches coupled to the first, second and third capacitors.

In this example the first capacitor C has a first terminal which is negative and a second terminal which is positive. The second capacitor Caux1 has a first terminal which is positive and a second terminal which is negative. Similarly, the second capacitor Caux2 has a first terminal which is positive and a second terminal which is negative.

The network of switches includes five switches labelled Q2 to Q6. The first switch Q2 couples the first terminal of the first capacitor C to the first terminal of the second capacitor Caux1. The second switch Q4 couples the first terminal of the second capacitor Caux1 to the first terminal of the third capacitor Caux2. The third switch Q6 couples the second terminal of the second capacitor Caux1 to the first terminal of the third capacitor Caux2. The fourth switch Q3 couples the first terminal of the first capacitor C to the second terminal of the third capacitor Caux2. The fifth switch Q5 couples the second terminal of the second capacitor Caux1 to the second terminal of the third capacitor Caux2. The switches Q3 and Q5 are coupled to ground via a diode D provided between node A and ground.

The second terminal (positive terminal) of the first capacitor C is coupled to the first terminal (positive terminal) of the second capacitor Caux1 via a voltage regulator. For instance, the voltage regulator may be a linear voltage regulator such as a Low-dropout regulator (LDO).

The network of switches is operable in a first phase to charge the second and third capacitors; and a second phase to charge the first capacitor by discharging the second and third capacitors. When the power switch Q1 is switched on, the network of switches operates in the first phase, and when the power switch Q1 is switched off, the network of switches operates in the second phase.

The first, second and third capacitors, together with switches Q2 to Q6 form a switch-capacitor circuit. In operation the switch-capacitor circuit provides high efficiency Vcc generation for the high side power switch Q1, across a wide range of output voltage conditions.

A Pulse Linear Regulator or LDO (not shown) may be provided between the drain terminal of Q1 and the output of the Vcc regulator in the same fashion as shown in FIG. 4. Such a PLR/LDO circuit may be used at start up but would not be used for normal operation.

The primary side of the power converter (not shown) may be implemented in different ways depending on the application. For instance, the primary side may be implemented as the primary side of FIG. 1.

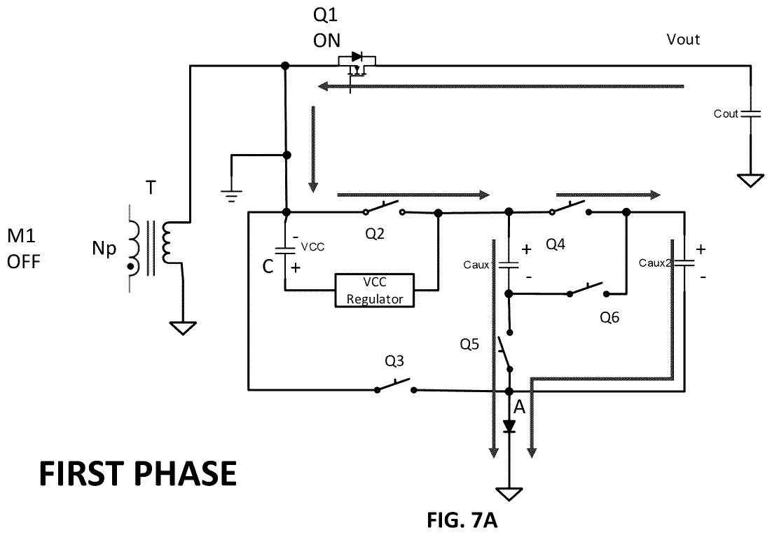

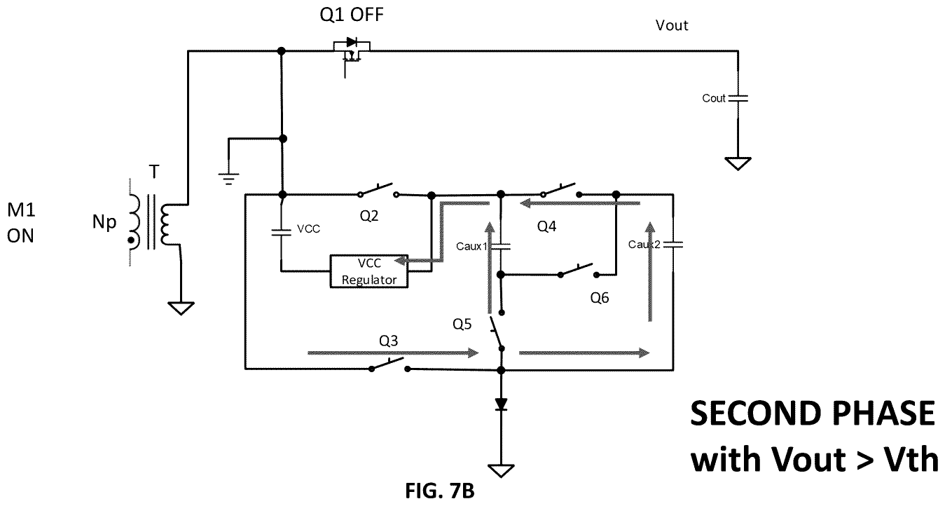

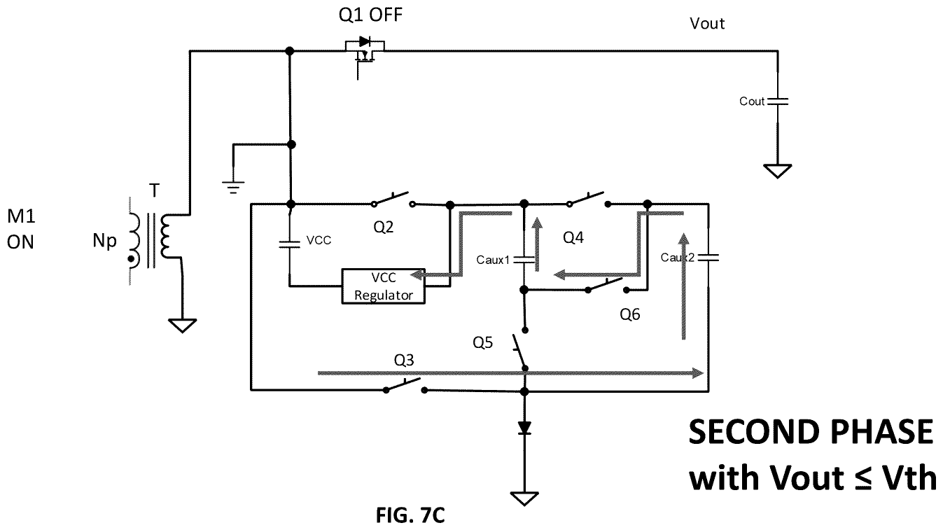

FIG. 7A is a diagram showing operation of the secondary side controller of FIG. 6 in the first phase.

In the first phase, the primary-side power switch M1 is in the OFF state, and the secondary-side power switch Q1 is in the ON state. This may correspond to the forward bias period of Q1. The switches Q2, Q4 and Q5 are switched ON (closed), while the switches Q3 and Q6 are switched OFF (open). The arrows show the current flow direction. The second and third capacitors Caux1 and Caux2 charge to a voltage Vout-Vfd, in which Vout is the output voltage of the converter and Vfd is the forward voltage drop of the diode D. For instance, Vfd may be about 0.5V.

FIG. 7B is a diagram showing operation of the secondary side controller of FIG. 6 in the second phase when the output voltage is above a threshold value Vth.

In the second phase, the primary-side power switch M1 is in the ON state, and the secondary-side power switch Q1 is in the OFF state. This may correspond to the reverse bias period of Q1. When an output voltage Vout of the isolated power converter is above a first threshold value, the second and third capacitors are coupled in parallel. For instance, the first threshold value may be a predetermined value set by a user and/or based on the implementation of the isolated power converter. For this example, a 6.5V threshold is selected, but other threshold values may be selected depending on the application, and/or specific implementation.

The switches Q3, Q4 and Q5 are switched ON (closed), while the switches Q2 and Q6 are switched OFF (open). The arrows show the current flow direction. The second and third capacitors Caux1 and Caux2 charge the first capacitor C via the VCC regulator. The voltage across the first capacitor C is labeled VCC. In this example, the first capacitor C is charged to Vout-Vfd.

FIG. 7C is a diagram showing operation of the secondary side controller of FIG. 6 in the second phase when the output voltage is equal or below the threshold value.

In the second phase, the primary-side power switch M1 is in the ON state, and the secondary-side power switch Q1 is in the OFF state. This may correspond to the reverse bias period of Q1. When an output voltage Vout of the isolated power converter is below the first threshold value, the second and third capacitors are coupled in series. For this example, a 6.5V threshold is selected, but other threshold values may be selected depending on the application, and/or specific implementation.

The switches Q3 and Q6 are switched ON (closed), while the switches Q2, Q4 and Q5 are switched OFF (open). The arrows show the current flow direction. The second and third capacitors Caux1 and Caux2 charge the first capacitor C via the VCC regulator. The voltage across the first capacitor C is labeled VCC. In this example, the first capacitor C is charged to 2*(Vout−Vfd).

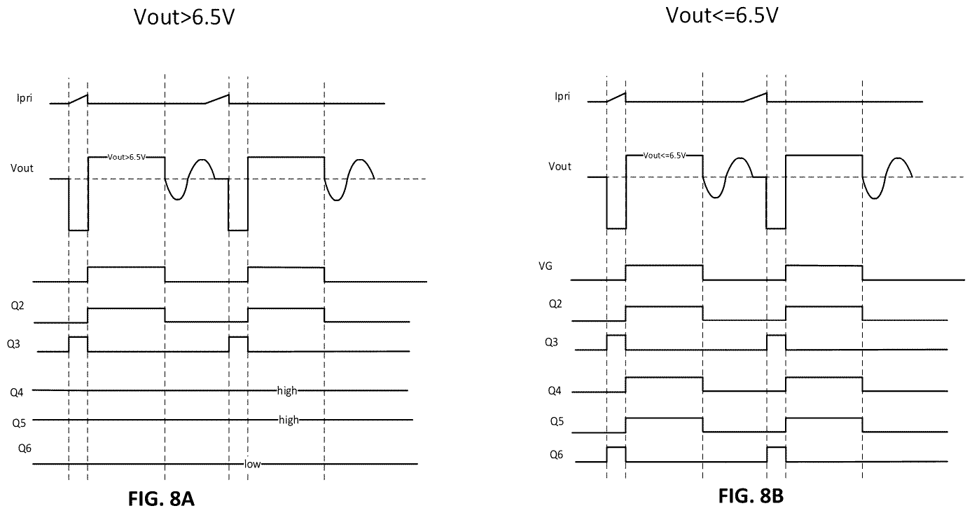

FIG. 8A is a waveform diagram illustrating operation of the secondary side controller of FIG. 6 when the output voltage is above the threshold value.

FIG. 8B is a waveform diagram illustrating operation of the secondary side controller of FIG. 6 when the output voltage is equal or below the threshold value.

FIGS. 8A and 8B show the waveforms of the primary current Ipri flowing through the primary winding of the transformer, the output voltage Vout of the converter, the gate voltage VG applied to the power switch Q1, and the states (low or high) of the switches Q2 to Q6.

The improvement in efficiency is illustrated by the following power loss calculation obtained for the system of FIG. 4 compared with the system of the disclosure with Vcc=7V, Cgs_Q1=5 nF, fs=40 kHz at Vout=5V, Vin=370V, Nps=4, Vout=5V.

For the system of FIG. 4, the VCC load current Icc=6V*5 nF*40 kHz=1.2 mA; Ploss=(370/4+5−7)*1.2 mA=109mW. For the system of the disclosure, the VCC load current Icc=6V*5 nF*40 kHz=1.2 mA; Ploss=((5−0.5)*2−7)*1.2 mA=2.4 mW.

The proposed controller of the disclosure allows for variations in output voltage conditions (high Vout and low Vout conditions) while maintaining high efficiency (reduced power losses), hence providing a versatile system.

A skilled person will appreciate that variations of the disclosed arrangements are possible without departing from the disclosure. Accordingly, the above description of the specific embodiments is made by way of example only and not for the purposes of limitation. It will be clear to the skilled person that minor modifications may be made without significant changes to the operation described.

1. A secondary side controller for use with an isolated power converter, the secondary side controller comprising:
a first capacitor for supplying a voltage to a power switch of a secondary side of the isolated power converter;
a second capacitor;
a third capacitor; and
a network of switches coupled to the first, second and third capacitors, the network of switches being operable in a first phase to charge the second and third capacitors; and a second phase to charge the first capacitor by discharging the second and third capacitors.

2. The secondary side controller as claimed in claim 1, wherein when the power switch is switched on, the network of switches operates in the first phase, and when the power switch is switched off, the network of switches operates in the second phase.

3. The secondary side controller as claimed in claim 1, wherein in the second phase the second and third capacitors are coupled in parallel when an output voltage of the isolated power converter is above a first threshold value; and wherein in the second phase the second and third capacitors are coupled in series when the output voltage is equal to or below the first threshold value.

4. The secondary side controller as claimed in claim 1, wherein the network of switches comprises
a first switch coupling a first terminal of the first capacitor to a first terminal of the second capacitor;
a second switch coupling the first terminal of the second capacitor to a first terminal of the third capacitor;
a third switch coupling a second terminal of the second capacitor to the first terminal of the third capacitor;
a fourth switch coupling the first terminal of the first capacitor to a second terminal of the third capacitor; and
a fifth switch coupling the second terminal of the second capacitor to the second terminal of the third capacitor.

5. The secondary side controller as claimed in claim 4, wherein in the first phase the first switch, the second switch, and the fifth switch are switched on; while the fourth switch and the third switch are switched off.

6. The secondary side controller as claimed in claim 4, wherein in the second phase the second switch, the fourth switch and the fifth switch are switched on; while the first switch, and the third switch are switched off to couple the second and third capacitors in parallel, when the output voltage is above the first threshold value; and
wherein in the second phase, the fourth switch and the third switch are switched on; while the first switch, the second switch and the fifth switch are switched off to couple the second and third capacitors in series, when the output voltage is equal or below the first threshold value.

7. The secondary side controller as claimed in claim 4, wherein a second terminal of the first capacitor is coupled to the first terminal of the second capacitor via a voltage regulator.

8. The secondary side controller as claimed in claim 1, wherein the network of switches is coupled to ground via a diode.

9. The secondary side controller as claimed in claim 1, further comprising a driver for driving a control terminal of the power switch.

10. An isolated power converter comprising:
a primary winding having a first terminal for receiving an input voltage and a second terminal coupled to a primary side ground via a primary power switch;
a secondary winding having a first terminal coupled to an output port via a secondary power switch and a second terminal coupled to a secondary side ground; and
a secondary side controller as claimed in claim 1, coupled to the secondary power switch.

11. The isolated power converter as claimed in claim 10, wherein the first capacitor of the secondary side controller is coupled to a first terminal of the secondary power switch.

12. The isolated power converter as claimed in claim 10, wherein the secondary power switch is a synchronous rectifier switch.

13. The isolated power converter as claimed in claim 10, implemented as a flyback converter.

14. A method of controlling a secondary side of an isolated power converter, the method comprising:
providing a first capacitor for supplying a voltage to a power switch of the secondary side of the isolated power converter;
providing a second capacitor and a third capacitor;
providing a network of switches coupled to the first, the second and the third capacitors;
operating the network of switches in a first phase to charge the second and third capacitors; and
operating the network of switches in a second phase to charge the first capacitor by discharging the second and third capacitors.

15. The method as claimed in claim 14, comprising:
coupling the second and third capacitors in parallel during the second phase, when an output voltage of the isolated power converter is above a first threshold value; and
coupling the second and third capacitors in series during the second phase, when the output voltage is equal to or below the first threshold value.
